(19) United States
(12) Patent Application Publication
(10) Pub. No.: US 2016/0060398 A1
(43) Pub. Date: Mar. 3, 2016

(54) METHOD OF MANUFACTURING CATIONIC POLYMERIZATION RESIN WITH ENHANCED UV STABILITY AND CATIONIC POLYMERIZATION RESIN MANUFACTURED BY THE SAME

(71) Applicant: Solip Tech Co., Ltd., Daejeon (KR)

(72) Inventors: Byeong-Soo BAE, Daejeon (KR); Gwang-Mun CHOI, Daejeon (KR); Ji-Hoon KO, Daejeon (KR)

(21) Appl. No.: 14/804,553

(22) Filed: Jul. 21, 2015

(30) Foreign Application Priority Data
Sep. 2, 2014 (KR) 10-2014-0116187

(51) Int. Cl. C08G 77/18

(52) U.S. Cl. CPC C08G 77/18

(57) ABSTRACT

The present invention relates to a cured product with excellent UV stability, which is manufactured using a resin composition containing a cation polymeric resin capable of cationic polymerization and a photostable cationic polymerization initiator in the form of an iodonium salt without adding an additional photoinitiator, and a method of manufacturing the cured product.

### CROSS-REFERENCE TO RELATED APPLICATION

This application claims priority to and the benefit of Korean Patent Application No. 10-2014-0116187, filed on Sep. 2, 2014, the disclosure of which is incorporated herein by reference in its entirety.

### BACKGROUND OF THE INVENTION

1. Field of the Invention

The present invention relates to a cured product with excellent UV stability, which is manufactured using a resin composition containing a cation polymeric resin capable of cationic polymerization and a photostable cationic polymerization initiator in the form of an iodonium salt without adding an additional photoinitiator, and a method of manufacturing the cured product.

2. Description of the Related Art

From the aspect of the material science, the materials we are using in our daily lives may be roughly categorized into metal materials, ceramic materials, and organic materials. Among them, the organic materials have various characteristics and advantages that cannot be achieved by other materials, and thus their use is on the increase. However, the organic materials, although having the above-described advantages, generally have a shorter product life than those of metal or ceramic materials, one of the reasons being ascribed to the deterioration in their durability such as discoloration when they are continuously exposed to sunlight. Accordingly, many studies have been conducted to solve the above problems and various resolutions for use have been proposed but there is still no satisfactory resolution to meet the UV stability.

Solar light promotes deterioration in most plastics, for example, the exposure of natural rubber to UV accelerates the oxidation about 3 times faster than in dark environments. Compared to the wavelength spectrum of solar light is in the range of from 0.7 nm to 1,000 nm, the actual UV irradiation exposed on earth is in the range of from 200 nm to 400 nm, being only part of the solar light, but it causes the degradation of plastics. The UV in the range of 300 nm wavelength has energy of 399 kJ/mol, which is higher than the C—C bonding energy, 335 kJ/mol, thus being sufficient for destroying the C—C bond.

Examples of stabilizers which can protect polymer resins from UV may include UV absorbers that absorb UV and converting it to heat energy, quenchers that interact with molecules activated by sunlight and release excess energy via IR radiation to obtain stabilization effect, radical scavengers such as polyethylene, polypropylene, ABS, etc., which have excellent effects on plastics. Representative examples of UV absorbers include benzophenone, benzotriazole, etc. Representative examples of quenchers include nickel butyldithiocarbamate, n-butylamine-nickel-2.2′-thio-bis-(4-tert octylphenolate), nickel(o-ethyl 3,5 di-tert-butyl-4-hydroxy benzyl)phosphonate, etc.

Korean Patent No. 10-1233625 proposes a preparation method for EVA sheet for solar cell encapsulant with improved discoloration stability and weather stability by forming the sheet by mixing a polymerizablephotostabilizer, a crosslinking agent, a silane coupling agent, and a UV absorbent to an ethylenevinyl acetate copolymer resin. That is, the patent suggests a method to improve discoloration stability and weather stability by preventing the degradation of ethylenevinyl acetate copolymer due to UV by adding a photostabilizer and a UV absorbent. As such, most conventional inventions suggest, as a method for improving UV stability, adding a photostabilizer and a UV absorbent. However, both the photostabilizer and the UV absorbent take on a yellow color, and thus their addition tend to increase the initial yellow index (YI). Additionally, in the case of the conventional patents, the results of measurements of the difference in yellow index (ΔYI) after UV irradiation for a certain amount of time for the evaluation of UV stability revealed high values of 3 to 5 or higher, which are recognizable by the naked eye. Accordingly, for the achievement of the YI values to a level not recognizable by the naked eye, there is a need for the development of a special method to achieve improved UV stability.

### CITATION LIST

### Patent Literature

Patent Literature 1: Korean Patent No. 10-1233625

### SUMMARY OF THE INVENTION

An object of the present invention is to provide a cured product with excellent UV stability using a composition containing a resin capable of a cationic polymerization, and a method for manufacturing the same. The wavelengths that induce the degradation of various plastics differ from each other, and also the stability of the plastics varies according to their molecular structures. Accordingly, it is necessary to select a suitable photostabilizer according to the plastics to be used and their uses. As such, the present invention aims to improve the photostability of a cured product of a cation polymeric resin containing an epoxy group having a C—O bond.

In particular, when a photostabilizer is used, an expected result may not be obtained if the dispersion is not uniform thereby making it difficult to uniformly disperse the photostabilizer on the resin.

The subject matters to be solved by the present invention are not limited to what have been described above, and other subject matters not described above may be clearly understandable to one of ordinary skill in the art based on the description set forth herein below.

Accordingly, the present invention aims to solve the above problems by providing a method of manufacturing a cationic polymerization resin with enhanced photostability, which includes: a step of mixing a cation polymeric resin and a photostable cation polymerization initiator without an additional photoinitiator (s100); a cation polymerization initiator; a step of performing a cationic polymerization via photo-irradiation or heat treatment on the mixture between the cation polymeric resin and the photostable cation polymerization initiatoracation polymerization initiator (s200); and a step of performing heat treatment at from 60° C. to 150° C. for from 30 min to 120 min; in which the cation polymerization initiator, in the step of mixing the cation polymeric resin and the photostable cation polymerization initiator (s100), includes an iodonium salt capable of absorbing a UV wavelength in the range of from 200 nm to 400 nm; the cation polymeric resin includes, per one molecule, at least one kind of a reactive group of a heterocycle or olefin capable of a cationic polymerization; the reactive group of a heterocycle or olefin capable of a cationic polymerization includes a C—C bond (bonding energy≈335 KJ/mol) and a C—O bond (bonding energy≈345 KJ/mol); and in the step of performing heat treatment at from 60° C. to 150° C. for from 30 min to 120 min (s300), the iodonium salt of the photostable cationic polymerization initiator is directly involved as an initiator in the polymerization reaction and is thus uniformly present on the cationic polymerization resin, which is a product of the polymerization reaction, at a constant ratio with the unit body of the cation polymeric resin; and a hard coating cured product manufactured by the method.

### BRIEF DESCRIPTION OF THE DRAWINGS

FIG. 1 is a graph illustrating the measurement result of UV stability in Examples and Comparative Examples of the present invention.

FIG. 2 is a schematic chart illustrating the sequential order of manufacturing a cationic polymerization resin with enhanced photostability of the present invention.

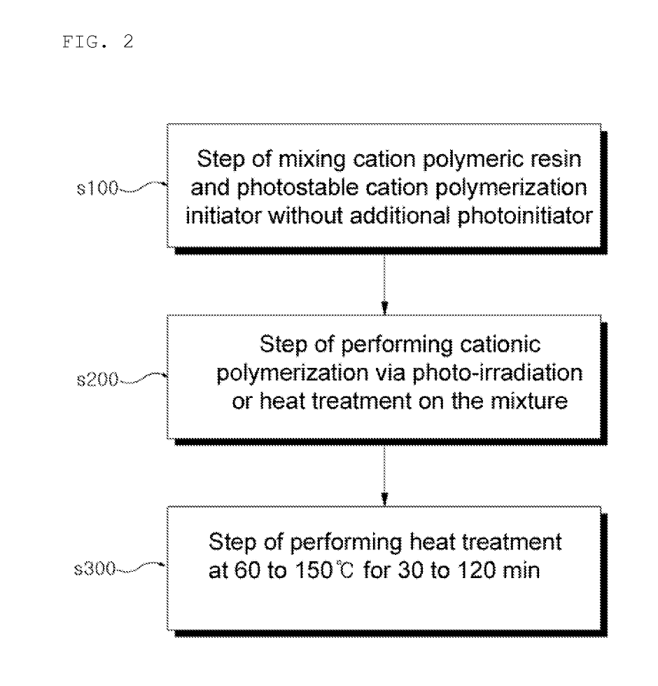

### DETAILED DESCRIPTION OF THE PREFERRED EMBODIMENTS

The present invention will be described in detail referring to the accompanying drawings. The present invention provides a method of manufacturing a cationic polymerization resin with enhanced photostability, which includes: a step of mixing a cation polymeric resin and a photostable cation polymerization initiator without an additional photoinitiator (s100); a cation polymerization initiator; a step of performing a cationic polymerization via photo-irradiation or heat treatment on the mixture between the cation polymeric resin and the photostable cation polymerization initiatora cation polymerization initiator (s200); and a step of performing heat treatment at from 60° C. to 150° C. for from 30 min to 120 min; in which the cation polymerization initiator, in the step of mixing the cation polymeric resin and the photostable cation polymerization initiator (s100), includes an iodonium salt capable of absorbing a UV wavelength in the range of from 200 nm to 400 nm; the cation polymeric resin includes, per one molecule, at least one kind of a reactive group of a heterocycle or olefin capable of a cationic polymerization; the reactive group of a heterocycle or olefin capable of a cationic polymerization includes a C—C bond (bonding energy≈335 KJ/mol) and a C—O bond (bonding energy≈345 KJ/mol); and in the step of performing heat treatment at from 60° C. to 150° C. for from 30 min to 120 min (s300), the iodonium salt of the photostable cationic polymerization initiator is directly involved as an initiator in the polymerization reaction and is thus uniformly present on the cationic polymerization resin, which is a product of the polymerization reaction, at a constant ratio with the unit body of the cation polymeric resin; and a hard coating cured product manufactured by the method.

Preferably, the iodoniumsaltiodonium salt is added in the amount of from 0.1 to 10 parts by weight with respect to 100 parts by weight of the cation polymeric resin. When the iodoniumsaltiodonium is added in the amount of less than 0.1 parts by weight with respect to 100 parts by weight of the cation polymeric resin, the cation polymeric resin may not be sufficiently polymerized. Additionally, when the iodoniumsaltiodonium is added in the amount of greater than about 10 parts by weight with respect to about 100 parts by weight of the cation polymeric resin, it may not only increase the yellow index (YI) of the cured product to be manufactured but also prevent UV stability of the same.

Preferably, the step (s100) of mixing the cation polymeric resin and the UV-stable cationic polymerization initiator is performed at the temperature below the initiation temperature or in the environment where the light is blocked.

Preferably, the heterocycle is at least one selected from the group consisting of a cyclic ether group including a glycidyl group, a cyclic epoxy group, an oxetane group, and an oxolane group; a cyclic sulfide group including a thiirane group, a thietane group, and a thiolane group; a lactone group; a lactam group; and a cylic amine group. Preferably, the olefin capable of the cationic polymerization includes an electron donating substituent in order to improve its reactivity. The above materials have a C—C bond (bonding energy≈335 KJ/mol) and a C—O bond (bonding energy≈345 KJ/mol). Accordingly, the iodoinum which absorbs UV with a wavelength in the range of from 200 nm to 400 nm having an energy of from 320 KJ/mol to 412 KJ/mol can act as a customized photostabilizer with respect to the cation polymeric resins.

A most preferable example of the cation polymeric resin may be an epoxy siloxane resin. Alternatively, a mixture between an epoxy siloxane resin and (3,4-epoxycyclohexyl)methyl 3,4-epoxycyclohexyl carboxylate. In particular, preferably, in the mixing ratio between the epoxy siloxane resin and (3,4-epoxycyclohexyl)methyl 3,4-epoxycyclohexyl carboxylate, the ratio of epoxy siloxane resin is high because the ratio of organic materials becomes small as the amount of the epoxy siloxane resin increases, more preferably in the range of from 7:3 to 5:5. The above mixing ratio of 5:5 will be explained in detail in Example 2 below.

Preferably, the iodoniumsaltiodonium salt is at least one selected from the group consisting of diphenyliodoniumhexafluorophosphate, phenyliodoniumhexafluoroantimonate, (4-isopropylphenyl)(p-tolyl)iodoniumtetrakis(perfluorophenyl)borate, ditolyliodoniumhexafluorophosphate, phenyl[2-(trimethylsilyl)phenyl]iodoniumtrifluoromethanesulfonate, bis(4-tert-butylphenyl)iodoniumtrifluoromethanesulfonate, bis(4-tert-butylphenyl)iodoniumhexafluorophosphate, bis(2,4,6-trimethylpyridine)iodoniumhexafluorophosphate, diphenyliodonium bromide, diphenyliodonium nitrate, diphenyliodonium chloride, diphenyliodonium iodide, (perfluoropropyl)phenyliodoniumtrifluoromethanesulfonate, (perfluoro-n-octyl)phenyliodoniumtrifluoromethanesulfonate, (perfluorohexyl)phenyliodoniumtrifluoromethanesulfonate, diphenyliodoniumtrifluoromethanesulfonate, diphenyliodonium-2-carboxylate monohydrate, (perfluoroisopropyl)phenyliodoniumtrifluoromethanesulfonate, ethinyl(phenyl)iodoniumtetrafluoroborate, bis(pyridine)iodoniumtetrafluoroborate, diphenyliodoniumhexafluoroarsenate, diphenyliodonium perchlorate, trimethylsilylethinyhphenypiodoniumtetrafluoroborate, bis(4- dodecylphenyl)iodoniumhexafluoroantimonate, (4-(2-hydroxytetradecyloxy)phenyl)(phenyl)iodoniumhexafluoroantimonate, and (4-(2-hydroxytetradecyloxy)phenyl)(phenyl)iodoniumhexafluorophosphate.

Additionally, in the step of mixing the cation polymeric resin and the photostable cation polymerization initiator (s100), an organic solvent may be further added in order to control the viscosity of the resin composition and the thickness of the cured product. Preferably, the organic solvent is at least one selected from the group consisting of acetone, methyl ethyl ketone, methyl butyl ketone, methyl isobutyl ketone, cyclohexanone, methyl cellosolve, ethyl cellosolve, cellosolve acetate, butyl cellosolve, ethyl ether, dioxane, tetrahydrofuran, methyl acetate, ethyl acetate, propyl acetate, isopropyl acetate, butyl acetate, isobutyl acetate, pentyl acetate, isopentyl acetate, butanol, 2-butanol, isobutyl alcohol, isopropyl alcohol, dichloromethane, chloroform, dichloroethane, trichloroethane, tetrachloroethane, dichloroethylene, trichloroethylene, tetrachloroethylene, chlorobenzene, o-dichlorobenzene, n-hexane, cyclohexanol, methylcyclohexanol, benzene, toluene, xylene, γ-butyrolactone, cyclohexanone, and propylene carbonate.

Furthermore, the present invention, with respect to a cationic polymerization resin for a hard coating cured product, provides a cationic polymerization resin with enhanced photostability manufactured by the above method for manufacturing the cationic polymerization resin with enhanced photostability. When a cured product with excellent UV stability is formed using the cationic polymerization resin with enhanced photostability, a forming process such as a casting, a molding, a coating, etc., may be preceded before initiating the iodonium salt.

Additionally, in order to obtain a uniform cured product after initiating the iodonium salt, it is possible to apply a subsequent heat treatment.

Hereinbelow, the present invention will be described in detail with reference to the exemplary embodiments but they should not be construed as limiting the scope of the present invention.

### EXAMPLE 1

Component A: Flex9H® (Solip Tech Co., Ltd., an epoxy siloxane resin)

Component B: diphenyliodoniumhexafluoroarsenate

After mixing component A and component B at the weight ratio of 100:1, the mixture was coated on a 1 mm-thick glass, whose surface was treated with oxygen plasma, at a thickness of 50 μm, and exposed to a mercury lamp to initiate the component B. The resultant was heat-treated at 80° C. for 60 min to obtain a sample.

### EXAMPLE 2

Component A1: (3,4-epoxycyclohexyl)methyl 3,4-epoxycyclohexyl carboxylate

Component A2: Flex9H® (Solip Tech Co., Ltd., an epoxy siloxane resin)

Component B: bis(4-dodecylphenyl)iodoniumhexafluoroantimonate

After mixing component A1, component A2, and component B at the weight ratio of 50:50:1, the mixture was coated on a 1 mm-thick glass, whose surface was treated with oxygen plasma, at the thickness of 50 μm, and exposed to a mercury lamp to initiate the component B. The resultant was heat-treated at 80° C. for 60 min to obtain a sample.

### EXAMPLE 3

Component A1: 3-ethyl-3[{(3-ethyloxetane-3-yl)methoxy}methyl]oxetane

Component A2: Flex9H® (Solip Tech Co., Ltd., an epoxy siloxane resin)

Component B: diphenyliodoniumhexafluorophosphate

After mixing component A1, component A2, and component B at the weight ratio of 50:50:1, the mixture was coated on a 1 mm-thick glass, whose surface was treated with oxygen plasma, at the thickness of 50 and exposed to a mercury lamp to initiate the component B. The resultant was heat-treated at 80° C. for 60 min to obtain a sample.

### COMPARATIVE EXAMPLE 1-1

Component A: Flex9H® (Solip Tech Co., Ltd., an epoxy siloxane resin)

A cation polymerization initiator: triarylsulfoniumhexafluoroantimonate

After mixing component A and a cation polymerization initiator at the weight ratio of 100:1, the mixture was coated on a 1 mm-thick glass, whose surface was treated with oxygen plasma, at the thickness of 50 μm, and exposed to a mercury lamp to initiate the cation polymerization initiator. The resultant was heat-treated at 80° C. for 60 min to obtain a sample.

### COMPARATIVE EXAMPLE 1-2

Component A: Flex9H® (Solip Tech Co., Ltd., an epoxy siloxane resin)

A cation polymerization initiator: triarylsulfoniumhexafluoroantimonate

A photostabilizer: Tinunvin®123 (BASF Company Ltd.)

After mixing component A, a cation polymerization initiator, and a photostabilizer at the weight ratio of 100:1:1, the mixture was coated on a 1 mm-thick glass, whose surface was treated with oxygen plasma, at a thickness of 50 μm, and exposed to a mercury lamp to initiate the cation polymerization initiator. The resultant was heat-treated at 80° C. for 60 min to obtain a sample.

### COMPARATIVE EXAMPLE 2-1

Component A1: (3,4-epoxycyclohexyl)methyl 3,4-epoxycyclohexyl carboxylate

Component A2: Flex9H® (Solip Tech Co., Ltd., an epoxy siloxane resin)

A cation polymerization initiator: triarylsulfoniumhexafluoroantimonate

After mixing component A1, component A2, and a cation polymerization initiator at the weight ratio of 50:50:1, the mixture was coated on a 1 mm-thick glass, whose surface was treated with oxygen plasma, at the thickness of 50 μm, and exposed to a mercury lamp to initiate the cation polymerization initiator. The resultant was heat-treated at 80° C. for 60 min to obtain a sample.

### COMPARATIVE EXAMPLE 2-2

Component A1: ((3,4-epoxycyclohexyl)methyl 3,4-epoxycyclohexyl carboxylate

Component A2: Flex9H® (Solip Tech Co., Ltd., an epoxy siloxane resin)

A cation polymerization initiator: triarylsulfoniumhexafluoroantimonate

A photostabilizer: Tinuvin 5100® (BASF Company Ltd.)

After mixing component A1, component A2, a cation polymerization initiator, and a photostabilizer at the weight ratio of 50:50:1:1, the mixture was coated on a 1 mm-thick glass, whose surface was treated with oxygen plasma, at the thickness of 50 μm, and exposed to a mercury lamp to initiate the cation polymerization initiator. The resultant was heat-treated at 80° C. for 60 min to obtain a sample.

### COMPARATIVE EXAMPLE 3-1

Component A1: 3-ethyl-3[{(3-ethyloxetane-3-yl)methoxy}methyl]oxetane

Component A2: Flex9H® (Solip Tech Co., Ltd., an epoxy siloxane resin)

A cation polymerization initiator: triarylsulfoniumhexafluoroantimonate After mixing component A1, component A2, and a cation polymerization initiator at the weight ratio of 50:50:1, the mixture was coated on a 1 mm-thick glass, whose surface was treated with oxygen plasma, at the thickness of 50 μm, and exposed to a mercury lamp to initiate the cation polymerization initiator. The resultant was heat-treated at 80° C. for 60 min to obtain a sample.

### COMPARATIVE EXAMPLE 3-2

Component A: 3-ethyl-3[{(3-ethyloxetane-3-yl)methoxy}methyl]oxetane

A cation polymerization initiator: triarylsulfoniumhexafluoroantimonate

A photostabilizer:Tinuvin 5100® (BASF Company Ltd.)

A UV absorbent:Tinuvin400® (BASF Company Ltd.)

After mixing component A1, component A2, a cation polymerization initiator, a photostabilizer, and a UV absorbent at the weight ratio of 50:50:1:1:0.5, the mixture was coated on a 1 mm-thick glass, whose surface was treated with oxygen plasma, at the thickness of 50 μm, and exposed to a mercury lamp to initiate the cation polymerization initiator. The resultant was heat-treated at 80° C. for 60 min to obtain a sample.

### <Method of Measurement>

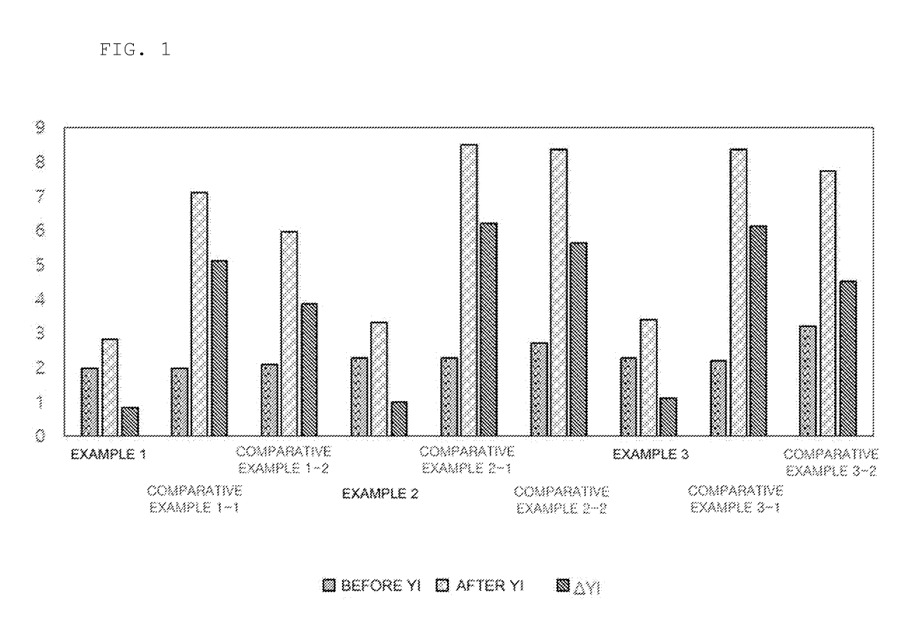

In order to measure the UV stability of cured products formed in Examples and Comparative Examples, each of the samples obtained therefrom was exposed to a UVB lamp (Peak: 306 nm, Power: 20 W) for 72 hours, and the Yellow Index before and after exposure was measured according to ASTM D1925 anc compared. The results are listed in Table 1 below and illustrated in a graph of FIG. 1.

TABLE 1

| | Before exposure | After exposure | |
|---|---|---|---|
| | (YI) | (YI) | ΔYI |
| Ex. 1 | 2.00 | 2.85 | 0.85 |
| Comp. Ex. 1-1 | 1.98 | 7.12 | 5.14 |
| Comp. Ex. 1-2 | 2.11 | 5.97 | 3.86 |
| Comp. Ex. 2 | 2.30 | 3.32 | 1.02 |
| Comp. Ex. 2-1 | 2.29 | 8.52 | 6.23 |
| Comp. Ex. 2-2 | 2.72 | 8.37 | 5.65 |
| Comp. Ex. 3 | 2.28 | 3.40 | 1.12 |
| Comp. Ex. 3-1 | 2.22 | 8.37 | 6.15 |
| Comp. Ex. 3-2 | 3.21 | 7.74 | 4.53 |

As can be seen in Table 1 and FIG. 1, it was confirmed that the cured products manufactured using the resin compositions containing the component A and the component B of the present invention exhibited extremely excellent UV stability.

Unlike the conventional method which uses an additional additive to improve UV stability, the present invention has an advantage in that a cured product with excellent UV stability can be manufactured using a resin composition containing a resin capable of a cation polymerization and a photostable cationic polymerization initiator in the form or an iodonium salt.

The iodonium salt absorbs UV with a wavelength in the range of from 200 to 400 nm having the energy of from 320 KJ/mol to 412 KJ/mol. The above energy range is sufficient to break the C—C bond (bonding energy≈335 KJ/mol) and the C—O bond (bonding energy≈345 KJ/mol). Accordingly, the iodonium salt which absorbs the UV in the above range can provide a customized photostability with respect to the cation polymeric resin having an epoxy group including the C—C bond and the C—O bond, thereby significantly improving UV stability.

Additionally, the iodonium salt of the present invention has an advantage in that it is added as a polymerization initiator not as an additional photostabilizer. The photostabilizer has a problem in that when it is not uniformly dispersed over the entire resin, it cannot expect sufficient photostability. In order to solve the problem, it is necessary to control the molecular weight of the photostabilizer or add an additional dispersing agent. However, the iodonium salt of the present invention is not added as an additional photostabilizer but as a polymerization initiator, directly involved in the cation polymerization reaction, and is thus uniformly present over the entire resin, which is a product of the polymerization reaction, at a constant ratio thereby being provided at high uniformity over the entire resin. Due to such uniformity, it is possible to expect UV stability with higher reliability.

Although exemplary embodiments of the present invention have been disclosed with reference to the accompanying drawing for illustrative purposes, it should be clearly understood that the forms of the present invention are illustrative only and are not intended to limit the scope of the present invention, and those skilled in the art will appreciate that various modifications, additions and substitutions are possible, without departing from the scope and spirit of the invention as disclosed in the accompanying claims. Additionally, it should be understood that some parts of the constitutions of the drawings are provided in an exaggerated or reduced form in order to explain the constitutions more clearly.

What is claimed is:

1. A method of manufacturing a cationic polymerization resin with enhanced photostability, the method comprising:
i) a step of mixing a cation polymeric resin and a photostable cation polymerization initiator without an additional photoinitiator(s100);
a cation polymerization initiator
ii) a step of performing a cationic polymerization via photo-irradiation or heat treatment on the mixture between the cation polymeric resin and the photostable cation polymerization initiatora cation polymerization initiator(s200); and
iii) a step of performing heat treatment at from 60° C. to 150° C. for from 30 min to 120 min;
wherein the cation polymerization initiator, in the step of mixing the cation polymeric resin and the photostable cation polymerization initiator (s 100), comprises an iodonium salt capable of absorbing a UV wavelength in the range of from 200 nm to 400 nm;
the cation polymeric resin comprises, per one molecule, at least one kind of a reactive group of a heterocycle or olefin capable of a cationic polymerization;
iodonium salt
the reactive group of a heterocycle or olefin capable of a cationic polymerization comprises a C—C bond (bonding energy≈335 KJ/mol) and a C—O bond (bonding energy≈345 KJ/mol); and
in the step of performing heat treatment at from 60° C. to 150° C. for from 30 min to 120 min (s300), the iodonium salt of the photostable cationic polymerization initiator is directly involved as an initiator in the polymerization reaction and is thus uniformly present on the cationic polymerization resin, which is a product of the polymerization reaction, at a constant ratio with the unit body of the cation polymeric resin.

2. The method of claim 1, wherein the iodonium salt is added in an amount of 0.1 to 10 parts by weight with respect to 100 parts by weight of the cation polymeric resin.

3. The method of claim 1, wherein the heterocycle is at least one selected from the group consisting of a cyclic ether group including a glycidyl group, a cyclic epoxy group, an oxetane group, and an oxolane group; a cyclic sulfide group including a thiirane group, a thietane group, and a thiolane group: a lactone group; a lactam group; and a cylic amine group.

4. The method of claim 1, wherein the olefin capable of the cationic polymerization includes an electron donating substituent in order to increase its reactivity.

5. The method of claim 1, wherein the iodonium salt is at least one selected from the group consisting of diphenyliodoniumhexafluorophosphate, phenyliodoniumhexafluoroantimonate, (4-isopropylphenyl)(p-tolyl)iodoniumtetrakis(perfluorophenyl)borate, ditolyliodoniumhexafluorophosphate, phenyl[2-(trimethylsilyl)phenyl]iodoniumtrifluoromethanesulfonate,bis(4-tert-butylphenyl)iodoniumtrifluoromethanesulfonate,bis(4-tert-butylphenyl)iodoniumhexafluorophosphate,bis(2,4,6-trimethylpyridine)iodoniumhexafluorophosphate,diphenyliodonium bromide, diphenyliodonium nitrate, diphenyliodonium chloride, diphenyliodonium iodide, (perfluoropropyl)phenyliodoniumtrifluoromethanesulfonate, (perfluoro-n-octyl)phenyl iodoniumtrifluoromethanesulfonate, (perfluorohexyl)phenyliodoniumtrifluoromethanesulfonate, diphenyliodoniumtrifluoromethanesulfonate, diphenyliodonium-2-carboxylate monohydrate, (perfluoroisopropyl)phenyliodoniumtrifluoromethanesulfonate, ethnyl(phenyl)iodoniumtetrafluoroborate, bis(pyridine)iodoniumtetrafluoroborate,diphenyliodoniumhexafluoroarsenate, diphenyliodonium perchlorate, trimethylsilylethinyl(phenyl)iodoniumtetrafluoroborate,bis(4-dodecylphenyl)iodoniumhexafluoroantimonate, (4-(2-hydroxytetradecyloxy)phenyl)(phenyl)iodoniumhexafluoroantimonate, and (4-(2-hydroxytetradecyloxy)phenyl)(phenyl)iodoniumhexafluorophosphate.

6. The method of claim 1, wherein, in the step of mixing the cation polymeric resin and the photostable cation polymerization initiator (s100), an organic solvent is further added in order to control the viscosity of the resin composition and the thickness of the cured product, and the organic solvent is at least one selected from the group consisting of acetone, methyl ethyl ketone, methyl butyl ketone, methyl isobutyl ketone, cyclohexanone, methyl cellosolve, ethyl cellosolve, cellosolve acetate, butyl cellosolve, ethyl ether, dioxane, tetrahydrofuran, methyl acetate, ethyl acetate, propyl acetate, isopropyl acetate, butyl acetate, isobutyl acetate, pentyl acetate, isopentyl acetate, butanol, 2-butanol, isobutyl alcohol, isopropyl alcohol, dichloromethane, chloroform, dichloroethane, trichloroethane, tetrachloroethane, dichloroethylene, trichloroethylene, tetrachloroethylene, chlorobenzene, o-dichlorobenzene, n-hexane, cyclohexanol, methylcyclohexanol, benzene, toluene, xylene, y-butyrolactone, cyclohexanone and propylene carbonate.

7. The method of claim 1, wherein the cation polymeric resin is an epoxy siloxane resin.

8. The method of claim 1, wherein the cation polymeric resin is a mixture between an epoxy siloxane resin and (3,4-epoxycyclohexyl)methyl 3,4-epoxycyclohexyl carboxylate.

9. A cationic polymerization resin with enhanced photostability, the cationic polymerization resin being manufactured by a method of manufacturing the cationic polymerization resin with enhanced photostability according to claim 1.
